(19) United States
(12) Patent Application Publication
(10) Pub. No.: US 2026/0103409 A1
(43) Pub. Date: Apr. 16, 2026

(54) HAIR CARE DEVICE COMPRISING VARIABLE NOZZLE UNIT FOR DISCHARGING ACIDIC WATER

(71) Applicant: JINNYS CO., LTD., Dangjin-si (KR)

(72) Inventor: Soo Jong KWON, Wonju-si (KR)

(73) Assignee: JINNYS CO., LTD., Dangjin-si (KR)

(21) Appl. No.: 19/375,388

(22) Filed: Oct. 31, 2025

Related U.S. Application Data
(63) Continuation of application No. PCT/KR2024/008738, filed on Jun. 25, 2024.

(30) Foreign Application Priority Data
Jul. 14, 2023 (KR) 10-2023-0091606

(51) Int. Cl. C02F 1/461; A45D 19/10; C02F 103/02

(52) U.S. Cl. CPC C02F 1/4618; A45D 19/10; C02F 2001/46185; C02F 2103/026; C02F 2201/46145; C02F 2201/4618; C02F 2209/06

(57) ABSTRACT

The present invention relates to a hair care device comprising a variable nozzle unit for discharging acidic water and, more specifically, to a hair care device comprising a variable nozzle unit for discharging acidic water, which supplies acidic water for a predetermined period of time to the hair cuticle damaged by exposure to an alkaline agent to perform perming, dyeing, or the like, thereby preventing continuous damage from alkaline residues and, at the same time, restores raised cuticle papillae to their original position to promote hair health, and is compatible with the hair positions of various users by varying the position of discharge nozzles according to the user's hair position.

### CROSS-REFERENCE TO RELATED APPLICATIONS

This application is a continuation of International Application No. PCT/KR2024/008738 filed on Jun. 25, 2024, which claims priority to Korean Patent Application No. 10-2023-0091606 filed on Jul. 14, 2023, the entire contents of which are herein incorporated by reference.

### TECHNICAL FIELD

The present invention relates to a hair care device comprising a variable nozzle unit for discharging acidic water and, more specifically, to a hair care device comprising a variable nozzle unit for discharging acidic water, which supplies acidic water for a predetermined period of time to the hair cuticle damaged by exposure to an alkaline agent to perform perming, dyeing, or the like, thereby preventing continuous damage from alkaline residues and, at the same time, restores raised cuticle papillae to their original position to promote hair health, and is compatible with the hair positions of various users by varying the position of discharge nozzles according to the user's hair position.

### BACKGROUND ART

In general, a hair cleaning device is a device configured to bring hair into proximity with a basin and clean the hair by spraying cleaning water onto the hair through a shower head or the like.

Further, the hair cleaning device comprises a basin for cleaning the hair, a stand supporting the basin and provided with a device for supplying cleaning water, and a pedestal supporting the stand.

Accordingly, a user can efficiently clean hair using the hair cleaning device.

However, in general, women's hair tends to become alkaline. That is, when performing a permanent (perm), a perm solution is applied to the hair after shampooing, the hair is wound around rods, and after heating for a predetermined time, the rods are removed to complete the perm. In this case, the perm solution is typically alkaline.

Accordingly, when hair is maintained in a permed state for a long period, it tends to become alkaline.

However, conventional hair cleaning devices merely perform the function of cleaning hair and have the problem of being unable to prevent the alkalization of hair as described above.

### DISCLOSURE

### Technical Problem

The present invention has been conceived to solve the above-mentioned problems, and an object thereof is to provide a hair care device comprising a variable nozzle unit for discharging acidic water, which supplies acidic water for a predetermined period of time to the hair cuticles damaged by exposure to an alkaline agent during perming, dyeing, or the like, thereby preventing continuous damage caused by residual alkaline agents and simultaneously restoring raised cuticle scales to their original positions to promote hair health.

Another object of the present invention is to provide a hair care device in which the position of the discharge nozzle can be varied according to the user's hair position, thereby making the device compatible with the hair positions of various users.

### Technical Solution

The present invention has the following features to solve the above-mentioned problems.

A hair care device according to the present invention, for improving a user's hair condition by discharging acidic water to the hair, comprises: an electrolysis unit configured to electrolyze water to generate alkaline water and acidic water; and an acidic water discharge unit configured to support the user's head portion and discharge the acidic water supplied from the electrolysis unit toward the user's hair, wherein the acidic water discharge unit is configured such that the position of a discharge nozzle for discharging acidic water toward the user's hair can be variably fixed.

Wherein the acidic water discharge unit comprises: a support housing configured to support the user's head portion and collect the acidic water discharged from the discharge nozzle and discharge the collected acidic water to the outside; and a variable nozzle unit coupled to the support housing and configured to discharge the acidic water supplied from the electrolysis unit to the user's head portion, while allowing the position of the discharge nozzle to be varied.

Further, the variable nozzle unit comprises: a flexible tube coupled to the support housing so as to allow its position to be varied, the flexible tube being connected to the electrolysis unit to receive the acidic water; and a discharge nozzle coupled to one end of the flexible tube to receive the acidic water delivered therethrough and discharge the received acidic water.

Further, the electrolysis unit comprises: a water storage unit configured to store water; a decomposition unit configured to receive water from the water storage unit, perform electrolysis, and generate acidic water and alkaline water; and an acidic water supply unit configured to supply the acidic water generated by the decomposition unit to the acidic water discharge unit.

Further, the electrolysis unit comprises: a concentration sensor configured to measure a pH concentration of the acidic water generated by the decomposition unit; an electrolyte supply unit configured to supply an electrolyte to the water storage unit; and a control unit configured to receive the pH concentration information from the concentration sensor and control the electrolyte supply unit to supply the electrolyte to the water storage unit when the measured pH concentration is lower than a preset concentration.

### Advantageous Effects

According to the present invention, acidic water is supplied for a predetermined period of time to hair cuticles damaged by exposure to an alkaline agent during perming, dyeing, or the like, thereby preventing continuous damage caused by residual alkaline agents and simultaneously restoring raised cuticle scales to their original positions, which promotes hair health.

In addition, the position of the discharge nozzle can be varied according to the user's hair position, making the device compatible with the hair positions of various users.

### DESCRIPTION OF DRAWINGS

FIG. 1 is a block diagram illustrating a schematic configuration of a hair care device according to an embodiment of the present invention.

FIG. 2 is a view illustrating an acidic water discharge unit according to an embodiment of the present invention.

FIG. 3 is a view illustrating a position-adjustable state of the flexible tube of the acidic water discharge unit according to an embodiment of the present invention.

FIG. 4 is a diagram illustrating a use state of the hair care device according to an embodiment of the present invention.

FIG. 5 is a block diagram illustrating a schematic configuration of a hair care device according to another embodiment of the present invention.

FIG. 6 is a view illustrating an acidic water discharge unit according to another embodiment of the present invention.

FIG. 7 is a diagram illustrating a use state of the hair care device according to another embodiment of the present invention.

### DETAILED DESCRIPTION

Referring to the accompanying drawings, embodiments of the present invention will be described in detail so that those skilled in the art can easily practice the invention. The present invention may be implemented in various forms and is not limited to the embodiments described herein. In the drawings, portions unrelated to the invention have been omitted to clearly illustrate the invention, and the same reference numerals are used throughout the specification for components that are identical or similar. Furthermore, detailed descriptions of well-known prior art are omitted.

Throughout the specification, when a certain element is described as “comprising” a particular component, it is intended, unless expressly stated otherwise, not to exclude the presence of other components but to allow the inclusion of additional components.

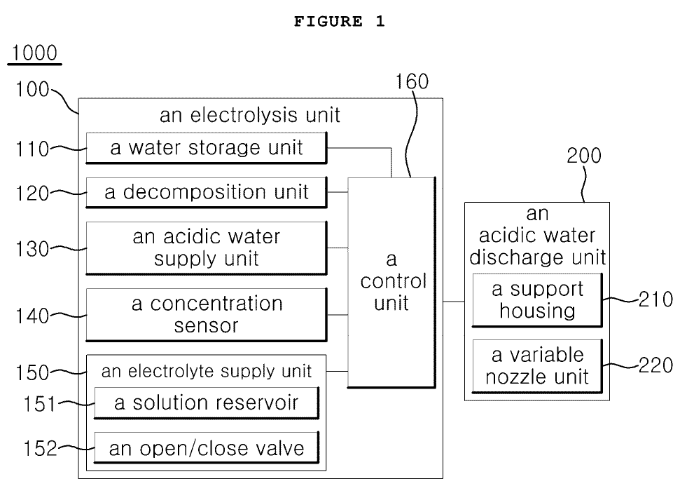

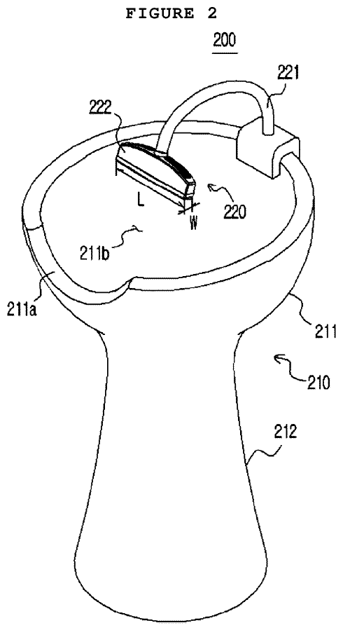

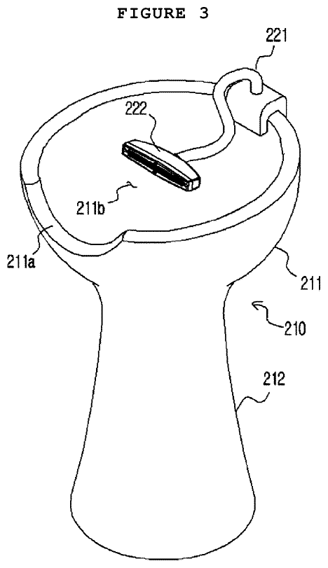

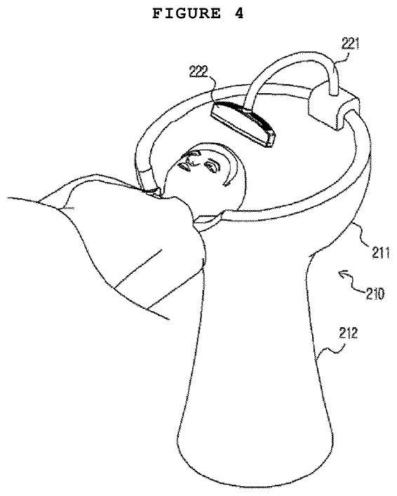

FIG. 1 is a block diagram illustrating a schematic configuration of a hair care device according to an embodiment of the present invention, FIG. 2 is a view illustrating an acidic water discharge unit according to an embodiment of the present invention, FIG. 3 is a view illustrating a position-adjustable state of the flexible tube of the acidic water discharge unit according to an embodiment of the present invention and FIG. 4 is a diagram illustrating a use state of the hair care device according to an embodiment of the present invention.

Referring to the drawings, a hair care device (1000) according to an embodiment of the present invention primarily comprises an electrolysis unit (100) configured to electrolyze water to generate alkaline water and acidic water, and an acidic water discharge unit (200) configured to support a user's head portion and discharge the acidic water supplied from the electrolysis unit (100) toward the user's hair.

The electrolysis unit (100) is configured to electrolyze stored water to separately generate acidic water and alkaline water. The electrolysis unit (100) comprises a water storage unit (110) configured to store water, a decomposition unit (120) configured to receive water from the water storage unit (110), perform electrolysis, and generate acidic water and alkaline water, and an acidic water supply unit (130) configured to supply the acidic water generated by the decomposition unit (120) to the acidic water discharge unit (200).

The electrolysis unit (100) described above generates acidic water to supply it to the acidic water discharge unit (200), which will be described later, and the decomposition unit (120) is provided with a positive electrode and a negative electrode.

In addition, an ion exchange membrane may be provided between the positive electrode and the negative electrode, and the ion exchange membrane may be an anion exchange membrane that allows only anions to be exchanged. Accordingly, cations from the positive electrode cannot pass through the ion exchange membrane to the negative electrode, whereas anions from the negative electrode can pass through the ion exchange membrane to the positive electrode.

With this configuration, when a power supply is applied to the positive and negative electrodes, acidic ions such as chloride ions and sulfate ions accumulate at the positive electrode to form acidic water, while alkaline ions such as calcium ions, magnesium ions, potassium ions, and sodium ions accumulate at the negative electrode to form alkaline water.

However, the configuration of the water storage unit (110) of the electrolysis unit (100) for producing acidic water in the present invention is not limited to the above-described arrangement, and any known configuration capable of generating acidic water may be used.

In addition, the electrolysis unit (100) may include a concentration sensor (140) configured to measure the pH of the acidic water generated by the decomposition unit (120), an electrolyte supply unit (150) configured to supply an electrolyte to the water storage unit (110), and a control unit (160) configured to receive pH information from the concentration sensor (140) and control the electrolyte supply unit (150) to supply the electrolyte to the water storage unit (110) when the measured pH is lower than a preset concentration.

The concentration sensor (140), the electrolyte supply unit (150), and the control unit (160) are provided to regulate the pH of the acidic water within a preset range, thereby supplying acidic water having a desired pH to the acidic water discharge unit (200) to promote the health of the user's hair.

In other words, in the present invention, when a user's hair is damaged as a result of performing a perm, dyeing, or the like, the hair cuticle may be lifted or separated in a protruding form, and such damaged cuticles can be restored through the use of acidic water.

Accordingly, in the present invention, acidic water generated by electrolyzing water is continuously sprayed in a predetermined amount onto a user's hair fixedly supported by the support housing (210) of the acidic water discharge unit (200), thereby preventing or restoring hair damage.

Accordingly, if the acidic water does not have a desired pH, effective prevention of hair damage cannot be achieved. Therefore, a concentration sensor (140) senses the pH and generates concentration information, and based on the generated concentration information, the control unit (160) supplies an electrolyte to the water storage unit (110) through the electrolyte supply unit (150) when necessary to increase the pH according to a preset reference.

Here, the electrolyte supply unit (150) may be provided with a solution reservoir (151) containing an electrolyte, and the electrolyte stored in the solution reservoir (151) may be supplied to the water storage unit (110) through an open/close valve (152).

Accordingly, when the pH of the acidic water currently generated by the decomposition unit (120) is higher than a preset pH, the control unit (160) opens the open/close valve (152) of the electrolyte supply unit (150) to supply a predetermined amount of electrolyte to the water storage unit (110). After a certain period, the pH information is checked by the concentration sensor (140), and if the pH falls within the preset range, no further electrolyte is supplied. If the pH still exceeds the preset value, additional electrolyte is supplied again.

With the configuration of the electrolysis unit (100) described above, acidic water having a desired pH can be generated and smoothly supplied to the acidic water discharge unit (200), which delivers the acidic water to the hair.

Meanwhile, the acidic water discharge unit (200) is configured to support the user's head portion and discharge the acidic water supplied from the electrolysis unit (100) toward the user's hair. In one embodiment of the present invention, the acidic water discharge unit (200) is configured such that the discharge nozzle (222) for discharging acidic water toward the user's hair can be variably positioned, allowing the discharge position to be selected according to the user's hair location.

To this end, the acidic water discharge unit (200) comprises a support housing (210) configured to support the user's head portion and collect the acidic water discharged from the discharge nozzle (222) for external discharge, and a variable nozzle unit (220) coupled to the support housing (210) and configured to discharge the acidic water supplied from the electrolysis unit (100) to the user's head portion, wherein the position of the discharge nozzle (222) is variable.

Here, the support housing (210) comprises an upper housing (211) having a recessed shape for supporting the user's head portion and collecting acidic water falling from the discharge nozzle, and a lower housing (212) configured to support the upper housing (211) and discharge the collected acidic water to the outside through a discharge pipe (not shown).

Here, the upper housing (211) may have a support groove (211a) formed at one upper side to support the neck portion so that the user's head portion is positioned toward the center of the upper housing (211), and a drain (not shown) may be formed at the recessed central area to communicate with the lower discharge pipe for discharging the collected acidic water to the outside.

The aforementioned electrolysis unit (100) may be accommodated within the lower housing (212) or may be provided separately outside the support housing (210).

Meanwhile, the variable nozzle unit (220) is coupled to the support housing (210) so that its position can be varied, and comprises a flexible tube (221) connected to the electrolysis unit (100) to receive acidic water, and a discharge nozzle (222) coupled to one end of the flexible tube (221) to receive and discharge the acidic water delivered therethrough.

Here, the flexible tube (221) is coupled to both upper ends of the upper housing (211) as shown in FIGS. 2 and 3, and is made of a flexible material that fixes and supports the discharge nozzle (222) while allowing its position to be variably adjusted.

Of course, the flexible tube (221) according to the present invention should be made of a material that satisfies both a certain degree of flexibility and the ability to maintain its fixed position.

The flexible tube (221) is, of course, configured to be in communication with the acidic water supply unit (130) of the electrolysis unit (100) to supply acidic water to the discharge nozzle (222).

In addition, the discharge nozzle (222) is preferably formed such that its horizontal length (L) approximately corresponds to the average face width of a typical user to enable uniform discharge toward the user's hair, and its width (W) is preferably formed to be between 1/10 and ⅕ of the horizontal length (L) for efficient discharge of the acidic water.

That is, if the width (W) of the discharge nozzle (222) is too large, a large amount of acidic water may not be discharged toward the user's hair but may flow directly toward the drain of the upper housing (211), resulting in waste of the acidic water.

In addition, if the width (W) is too small, the acidic water may not be discharged across the entire front of the user's hair but only over a partial area; therefore, as described above, it should be formed to be between 1/10 and ⅕ of the horizontal length (L).

Through the hair care device (1000) according to one embodiment of the present invention, acidic water is supplied to the user's hair damaged by a perm, dyeing, or the like, thereby neutralizing it to prevent additional damage, and restoring the raised cuticle projections toward the central portion to maintain healthy hair.

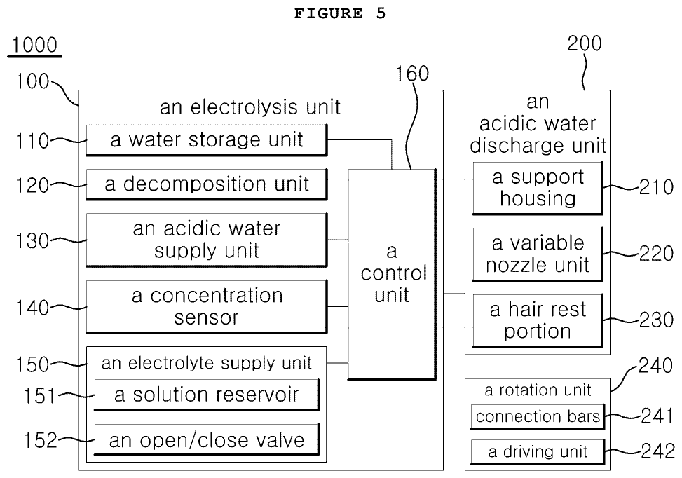

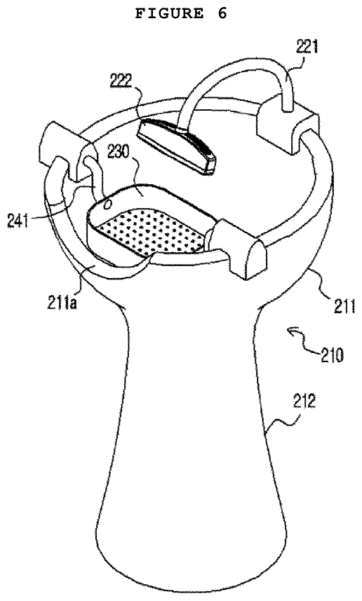

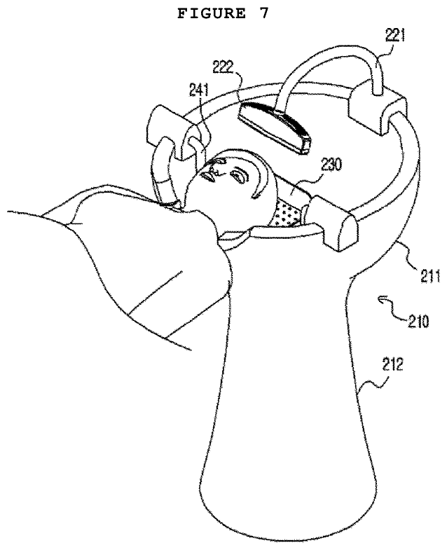

FIG. 5 is a block diagram illustrating a schematic configuration of a hair care device according to another embodiment of the present invention, FIG. 6 is a view illustrating an acidic water discharge unit according to another embodiment of the present invention and FIG. 7 is a diagram illustrating a use state of the hair care device according to another embodiment of the present invention.

Referring to the drawings, the acidic water discharge unit (200) according to the present embodiment is installed such that a hair rest portion (230) is positioned at a predetermined distance below the user's head while the user's head is supported by the support groove (211a) in the recessed portion (211b) of the upper housing (211).

The hair rest portion (230) is configured to accommodate the lower portion of the hair when the user is female and has long hair, and to temporarily hold the acidic water discharged from the discharge nozzle (222) as it passes along one side of the user's hair and falls downward.

Accordingly, in the case of a user with long hair, the lower portion of the hair may not be directly supplied with acidic water from the discharge nozzle (222); however, through the hair rest portion (230), the acidic water can be smoothly supplied to the hair.

In addition, the hair rest portion (230) is not merely fixed in position to accommodate the lower portion of the hair, but is configured to be rotatable through connection with a rotation unit (240), as shown in FIGS. 5 and 6, so that the accommodated hair and the acidic water can be shaken to facilitate uniform supply of the acidic water to the hair.

To this end, the rotation unit (240) is supported and accommodated in the recessed portion (211b) of the upper housing (211) through connection bars (241) protruding from both sides of the upper portion of the upper housing (211), and the connection bars (241) are configured to be repetitively rotatable by a driving unit (242) through a predetermined angle.

In addition, the hair rest portion (230) has a predetermined accommodation space and is formed in a hexahedral shape with an open upper side, and a plurality of through-holes are formed in the bottom surface so that the accommodated acidic water can be discharged downward.

Here, the diameter and number of the through-holes are preferably configured such that the discharged acidic water can be discharged in an amount corresponding to the amount collected in the hair rest portion (230).

In addition, the rotation angle of the driving unit (242) is preferably within a range of 5° to 20° in either or both the forward and rearward directions based on the vertical direction when the hair rest portion (230) is positioned on a horizontal plane, and more preferably, the rotation angle should be within 5° to 10°.

Although the drawings do not illustrate the specific rotation configuration of the driving unit (242) and the connection bars (241), it should be noted that a configuration in which the driving unit (242), such as a motor or a pneumatic cylinder, is connected to the connection bars (241) to rotate the connection bars (241) is conventional and well-known in the art, and thus is omitted.

Although the preferred embodiments of the present invention have been described above, the present invention is not limited to the specific embodiments described above. That is, those skilled in the art to which the present invention pertains may make various modifications and changes to the present invention without departing from the spirit and scope of the appended claims, and all such suitable modifications and changes should be considered to fall within the scope of the present invention as equivalents.

1. A hair care device for improving a hair condition by discharging acidic water to a user's hair, comprising:
an electrolysis unit (100) configured to electrolyze water to generate alkaline water and acidic water; and
an acidic water discharge unit (200) configured to support the user's head portion and discharge the acidic water supplied from the electrolysis unit (100) toward the user's hair,
wherein the acidic water discharge unit (200) comprises a discharge nozzle (222) configured to variably fix a position for discharging the acidic water toward the user's hair.

2. The hair care device according to claim 1,
wherein the acidic water discharge unit (200) comprises:
a support housing (210) configured to support the user's head portion and collect the acidic water discharged from the discharge nozzle (222) and discharge the collected acidic water to the outside; and
a variable nozzle unit (220) coupled to the support housing (210) and configured to discharge the acidic water supplied from the electrolysis unit (100) to the user's head portion, while allowing a position of the discharge nozzle (222) to be varied.

3. The hair care device according to claim 2,
wherein the variable nozzle unit (220) comprises:
a flexible tube (221) coupled to the support housing (210) so as to allow its position to be varied, the flexible tube (221) being connected to the electrolysis unit (100) to receive the acidic water; and
a discharge nozzle (222) coupled to one end of the flexible tube (221) to receive the acidic water delivered therethrough and discharge the received acidic water.

4. The hair care device according to claim 1,
wherein the electrolysis unit (100) comprises:
a water storage unit (110) configured to store water;
a decomposition unit (120) configured to receive water from the water storage unit (110), perform electrolysis, and generate acidic water and alkaline water; and
an acidic water supply unit (130) configured to supply the acidic water generated by the decomposition unit (120) to the acidic water discharge unit (200).

5. The hair care device according to claim 4,
wherein the electrolysis unit (100) further comprises:
a concentration sensor (140) configured to measure a pH concentration of the acidic water generated by the decomposition unit (120);
an electrolyte supply unit (150) configured to supply an electrolyte to the water storage unit (110); and
a control unit (160) configured to receive the pH concentration information from the concentration sensor (140) and control the electrolyte supply unit (150) to supply the electrolyte to the water storage unit (110) when the measured pH concentration is lower than a preset concentration.
